(19) United States
(12) Patent Application Publication
(10) Pub. No.: US 2013/0086646 A1
(43) Pub. Date: Apr. 4, 2013

(54) Method to Safeguard the Authorized Access to a Field Device used in Automation-Technology

(71) Applicant: Endress + Hauser Process Solutions AG, Reinach (CH)

(72) Inventors: Axel Poschmann, Basel (CH); Eric Birgel, Schopfheim (DE); Juerg Wyss, Ettingen (CH)

(73) Assignee: Endress + Hauser Process Solutions AG, Reinach (CH)

(21) Appl. No.: 13/644,354

(22) Filed: Oct. 4, 2012

(30) Foreign Application Priority Data
Oct. 4, 2011 (DE) DE102011083984.4

(51) Int. Cl. H04W 12/08

(52) U.S. Cl. CPC H04W 12/08
USPC 726/4

(57) ABSTRACT

A method of safeguarding the authorized access to field a device used in automation-technology, wherein the field device comprises an internet protocol capable interface as well as an interface for near field communication. The method comprises a unique factory installed access code for an authorized field device user is stored in the field device or clearly assigned to the field device; before delivery of the field device from a field device supplier to a field device user The unique factory installed access code for an authorized field device user is read from the field device through the near field communication interface means of a mobile service unit with the use of a Security App, made available by the field device supplier, or through an alternatively made available, and secure, channel of communication; access authorization for the field device is established by means of the Security App for at least one authorized field device user; and operation of the field device is accomplished by the authorized field device user with the established access authorization by means of the mobile service unit or the internet protocol capable interface.

The invention relates to a method of safeguarding the authorized access to a field device used in automation-technology, wherein the field device comprises an internet protocol capable interface as well as an interface for near field communication.

In automation-technology, and especially in process and manufacturing automation-technology, a variety of field devices are used to register and/or influence process variables. Sensors are used to measure process variables, such as, for example, fill level measuring devices, flow measuring devices, pressure and temperature measuring devices, pH-redox potential measuring devices, conductivity measuring devices, etc., which register the corresponding process variables, fill level, flow, pressure, temperature, pH-value, or conductivity. Serving for influencing process variables are actuators, such as, for example, valves or pumps, via which the flow of a liquid in a section of pipeline, or the fill level in a container, can be changed.

Field devices are, in principle, all devices, which are employed near to the process and deliver or process relevant information. In the context of the present invention the term field device is to be understood to refer also to general units, such as remote I/Os, gateways, linking devices and wireless adaptors, which are employed in the field. Here one often associates the term network components. A large variety of such field devices are produced and sold by the Endress+Hauser group of companies.

In modern industrial plants, communication is made between at least one superordinate control unit and field devices via fieldbus systems (systems such as e.g. ProfiBus®, Foundation Fieldbus®, HART®, etc.). These fieldbus systems can be hardwired together or be wirelessly equipped. The superordinate unit serves for process control, process visualizing, process monitoring, as well as for the commissioning and operation of the field devices and is also referred to as a configuration/management system. Some programs that run autonomously on superordinate units are, for example, the software tool FieldCare by the Endress+Hauser group of companies, the software tool Pactware, the software tool AMS by Fisher-Rosemount or the software tool PDM by Siemens. Software tools, which are integrated in control system applications, include PCS7 by Siemens, Symphony by ABB and Delta V by Emerson. The phrase “operation of the field devices” is understood especially to mean the configuring and parameterizing of the field devices, as well as running diagnostics in order to quickly detect errors in the field devices or process. Still, the term “operation” implies, in the simplest case and in the context of the invention, the simple displaying of information.

More and more field devices and network components comprise Internet protocol capable interfaces. The inclusion of these internet protocol capable interfaces represents a potential weak spot with regard to the high security requirements inherent in factory automation machinery, given that they make possible unauthorized access to the field devices. In addition to this, standard practice in the delivery of field devices and network components is to ship them either completely without, or with, default access data such as usernames, passwords and IP addresses. Typically, this default access data is not altered.

A disadvantage of the current solution is that factory installed user settings for access protection are not confidential and therefore not secure. Also, normally no modifications of the user access data is made after the start of operations. Even a user administration, following FDA regulations, which require a username and password, does not include a two way authentication (certificate) for encrypted information.

Moreover, internet protocol capable interfaces are often used as system interfaces and service interfaces, through which modifications of the user access data can be made. Thus, these interfaces present a security risk because it is possible for an unauthorized third party to gain access to the field devices, and the network wherein they are integrated, through an internet protocol capable interface, and thereby, as an example, tap into the data traffic.

It is an object of the present invention to propose a method which allows access to a field device, exclusively with authorization. Under the term “access” to the field devices with respect to the invention, is understood to be meant read write access as well as read only access.

This object is achieved in accord with the inventive method, which comprises the following steps:
Before delivery of the field device from a field device supplier to a field device user, a unique factory installed access code for an authorized field device user is stored in the field device or clearly assigned to the device;
The unique factory installed access code for an authorized field device user is read from the field device through the near field communication interface by means of a mobile service unit with the use of a Security App, made available by the field device supplier, or through an alternatively made available, and secure, channel of communication;
Access authorization for the field device is established by means of the Security App for at least one authorized field device user;
Operation of the field device is accomplished by the authorized field device user with the established access authorization by means of the mobile service unit or the internet protocol capable interface.

In summary, through the invention it is possible to securely establish authorized access to the field device from the manufacturing plant on. An encrypted near field communication channel and a mobile processing unit is used along with the internet protocol capable transmission channel.

By way of example, RFID technology, near field communication technology or Bluetooth-technology is employed for near field communication. Also by way of example, an iPhone, iPad, Android Tablet, or a proprietary service console such as FieldExpert could be employed as a mobile service unit.

An advantageous embodiment of the inventive method provides a code for the secure near field communication between the mobile service unit and the field device is stored in the Security App. The mobile service unit uses the Security App to read out the access code for the secure near field communication interface.

It is further provided that by means of the Security App the user administration for the field device is established and/or an equivalent client certificate for secure access to the field device is assigned.

An advantageous embodiment of the inventive method provides for the Internet protocol capable interface to be set up so that an encrypted client and server/supplier side authenticated communication is secured. This can be effected with, e.g. PIN and TAN.

Furthermore it is provided, in the context of the invention, that at least one client certificate for at least one authorized SoftwareClient, e.g. the software tool FieldCare, is transmitted to the field device and assigned to the field device, respectively, by the supplier before delivery so that a two way authenticated encryption is already initially available.

Preferably, the mobile service unit further provides at least one client certificate of the field device to external keystores, for client software from third-party providers.

It is viewed as advantageous in the context of the invention when at least one client certificate is transmitted over the wireless or hardwired interface to external keystores.

Advantages of the method according to the invention are listed below as follows:
Security which has no loopholes is achieved for the life cycle of the field device and network components because access via the Internet protocol capable interface is only possible after the establishment of the user administration and the storing of the certificate.

The typically used standard passwords are replaced by individual passwords; change in the original access data is accomplished via a second secure communication channel.
Encrypted client and server side authenticated communication via the system interface is made possible and secure.
At any point in time, only one authorized access to the field device, with defined read only or read write permission, can take place.
Through verification of client certificates, DoS (Denial of Service) attacks can be averted early on and effectively, such that through the method according to the invention the robustness of the network is substantially enhanced.

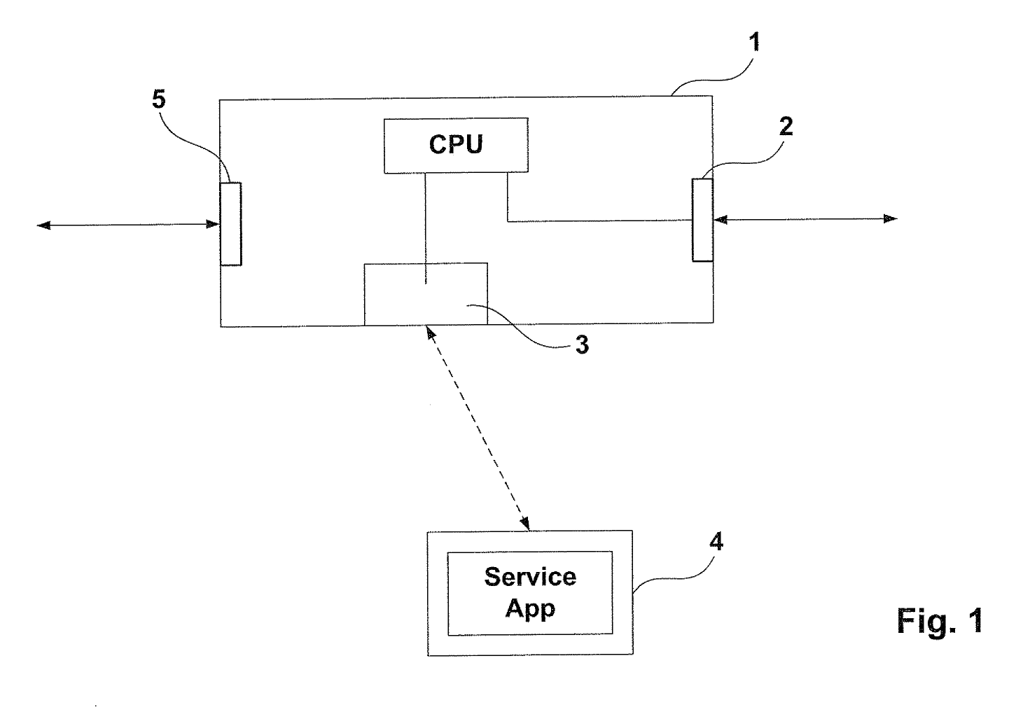

The invention is now described in greater detail based on the appended drawing, FIG. 1. FIG. 1 shows the embodiment of a field device 1, on which the method according to the invention is realizable.

The field device is connected to a fieldbus system via a fieldbus interface 5. The fieldbus system is not separately pictured in FIG. 1. Via the fieldbus system—an assorted variety have been named as examples—the field device 1 communicates with other field devices and/or with a (also not pictured in FIG. 1) superordinate control unit. Examples of the corresponding control units have also already been named in the introduction of the description of the present patent application. The fieldbus interface 5 can have a hardwired as well as wireless setup.

Furthermore, the field device 1 comprises an Internet protocol capable interface 2 and an interface for near field communication 3. The field device 1 is reachable with an IP address via the Internet protocol capable interface 2. This system interface 2 is, according to the invention, secured so that exclusively authorized accesses to the field device 1 are possible.

In an alternate arrangement, the field device 1 simply comprises an internet protocol capable interface 2. The fieldbus interface 5 is generally only provided if the field device, in the field, communicates with a superordinate control unit by means of a process access protocol (PAP) or a gateway. Communication using the internet protocol capable interface 2 is achieved through wireless or hardwired data transmission.

The field device 1 is brought into operation as a part of the automated factory machinery using the near field communication interface 3. For near field communication, one can use, for example, RFID technology, near field communication technology, or Bluetooth technology.

The inventive method comprises the following steps:
1. Before delivery of the field device 1 from a field device supplier to a field device user, a unique factory installed access code (or as the case may be, customized access data) for an authorized field device user is stored in the field device 1 or clearly assigned to the field device 1.
2. The unique factory assigned access code for an authorized field device user is read from the field device 1 through the near field communication interface 3 by means of a mobile service unit 4 with the use of a Security App, made available by the field device supplier, or through an alternatively made available, and secure, channel of communication. By way of example, an iPhone, iPad, Android Tablet, or a proprietary service console such as FieldExpert is employed as a mobile service unit 4.
3. Access authorization for the field device 1 is established for at least one authorized field device user by means of the Security App.
4. Operation of the field device 1 is accomplished by the authorized field device user with the established access authorization by means of the mobile service unit 4 or the internet protocol capable interface 2.

1-9. (canceled)

10. A method to safeguard the authorized access to field devices used in automation-technology, wherein the field device comprises an internet protocol capable interface and an interface for near field communication, the method comprises the steps of:
storing in the field device or clearly assigned to the field device before delivery of the field device from a field device supplier to a field device user, a unique factory assigned access code for an authorized field device user;
the unique factory assigned access code for an authorized field device user from the field device through the near field communication interface by means of a mobile service unit with the use of a Security App, made available by the field device supplier, or through an alternatively made available, and secure, channel of communication;
establishing access authorization for the field device for at least one authorized field device user with the Security App; and
accomplishing operation of the field device by the authorized field device user with the established access authorization by means of the mobile service unit or the internet protocol capable interface.

11. The method as claimed in claim 10, wherein:
by way of example, RFID technology, near field communication technology or Bluetooth-technology is employed for near field communication.

12. The method as claimed in 10, wherein:
by way of example, an iPhone, iPad, Android Tablet, or a proprietary service console such as, for example, FieldExpert is employed as a mobile service unit.

13. The method as claimed in claim 10, further comprising the step of:
storing a code for the secure near field communication between the mobile service unit and the field device in the Security App., wherein:
the mobile service unit uses the Security App to read out the access code for the secure near field communication interface.

14. The method as claimed in claim 10, wherein:
by means of the Security App, the user administration for the field device is established and/or an equivalent client certificate for secure access to the field device is assigned.

15. The method as claimed in claim 10, wherein:
the internet protocol capable interface is set up so that an encrypted, client and supplier side authenticated communication is secured.

16. The method as claimed in claim 14, wherein:
at least one client certificate for at least one authorized SoftwareClient, e.g. the software tool FieldCare, is transmitted to the field device and assigned to the field device, respectively, by the supplier before delivery so that a two way authenticated encryption is initially available.

17. The method as claimed in claim 10, wherein:
the mobile service unit makes available at least one client certificate of the field device to external keystores, for client software from third-party providers.

18. The method as claimed in 17, wherein:
at least one client certificate is transferred over the wireless or hardwired interface to external keystores.
